(19) United States
(12) Patent Application Publication
(10) Pub. No.: US 2026/0254838 A1
(43) Pub. Date: Aug. 27, 2026

(54) SYSTEMS AND METHODS FOR NETWORK SECURITY MONITORING AND ENFORCEMENT

(71) Applicant: MGT Impact Solutions, LLC, Tampa, FL (US)

(72) Inventors: Bradford Lance Goodman, Suwanee, GA (US); William Raynor McLendon, Atlanta, GA (US)

(21) Appl. No.: 19/545,270

(22) Filed: Feb. 20, 2026

Related U.S. Application Data
(60) Provisional application No. 63/761,353, filed on Feb. 21, 2025.

(51) Int. Cl. H04L 9/40

(52) U.S. Cl. CPC H04L 63/1433; H04L 63/1425

(57) ABSTRACT

In some aspects, a non-transitory computer-readable storage medium having program code executable by a processing device to perform operations is described. The operations can include receiving, from an edge device, performance data, vulnerability data, and an endpoint. The operations can include generating a security score based on the performance data and the vulnerability data and assigning the security score to the endpoint. In response to determining the security score exceeds a predetermined threshold, the operations can include generating a mitigating action that reduces accessibility of the endpoint to a computing network.

### CROSS-REFERENCE TO RELATED APPLICATIONS

This application claims the benefit of U.S. Provisional Application No. 63/761,353, filed Feb. 21, 2025, the entire contents of each of which is incorporated herein by reference in its entirety for all purposes.

### TECHNICAL FIELD

The present disclosure relates generally to network security. More specifically, but not by way of limitation, this disclosure relates to systems and methods for network security monitoring and enforcement.

### BACKGROUND

With increasing risks associated with cyberattacks and a growing need to secure computer networks, continuous and efficient monitoring is a priority of computer network security teams. However, as computer network environments expand and grow in complexity, being able to interpret vast amounts of security event data becomes a challenging task. Intrusion detection software (“IDS”) including traffic monitoring tools and honeypot systems can be used to determine threat signatures and uncover attack methods, providing valuable data. However, analyzing this information, to provide network security status in real-time is difficult, especially in larger networks.

### SUMMARY

Various embodiments of the present disclosure provide techniques for network security monitoring and enforcement. In one example, a non-transitory computer-readable storage medium having program code executable by a processing device to perform operations is described. The operations can include receiving, from an edge device, performance data and vulnerability data, and further receiving an endpoint (e.g., an internet protocol “IP” address) from the edge device. The operations can include generating a security score based on correlating the performance data and the vulnerability data and assigning the security score to the endpoint. In response to determining the security score exceeds a predetermined threshold, the operations can include generating a mitigating action where the mitigating action reduces accessibility of the endpoint to a computing network.

In further aspects, methods including the above described operations and systems with non-transitory computer-readable storage medium with instructions for executing the above described operations are described.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF THE DRAWINGS

FIG. 1 is a block diagram depicting an example of a computing environment in which a network security monitoring system can generate closed loop actions to remedy determined security threats, according to certain examples.

FIGS. 2A and 2B are sequence diagrams depicting example sequences of operations for providing closed loop network security on edge devices, according to certain examples.

FIG. 3 is a flow diagram of a process for executing closed loop actions to implement security access control, according to certain examples.

FIG. 4 is a block diagram depicting an example of a computing device, which can be used to implement instructions executed via the edge cloud service, the client computing environment, or both, according to certain examples.

### DETAILED DESCRIPTION

Certain aspects and features of the present disclosure address issues related to network security via real-time network monitoring, data analysis, and generation of mitigating actions within a closed loop network of a larger computer environment.

A collection of software and device components are described, each configured to serve various roles in the implementation of the described network security environment. Such components include an edge device and edge agent, each deployed within the same client environment, where the edge device and edge agent can be physically connected to one another. The edge device and edge agent can be communicatively coupled, via communication links, to a larger computing network. The edge device can connect to wired and wireless network environments, for instance including a client environment and a central environment for data analysis and mitigating action determination.

The edge device can operate in multiple modes for gathering data, including modes where the edge device acts as a client and executes various tests to verify network performance, and modes where the edge device acts as a honeypot system to trace internet protocol (“IP”) addresses, report security events, and generate vulnerability data. The edge device can also report attacks the edge device identifies as directly targeting the edge device. The data gathered by the edge device can be uploaded to an edge cloud computing environment for further analysis and determination of mitigating actions to implement on the edge agent.

The edge agent, operating in the same client environment as the edge device, can execute mitigating actions as identified by the edge cloud computing network. Because the edge device and edge agent operate in the same environment, the described system is said to operate in a closed loop, where the same environment which perceives a threat (via the edge device), executes mitigating actions to prevent or otherwise inhibit the threat (via the edge agent). The edge agent can execute mitigating actions such as quarantining users and/or reconfiguring firewalls via external dynamic lists to prevent or otherwise inhibit traffic associated with a determined threat actor.

The edge cloud service, acting as an intermediary between the edge agent and edge device can process the data received by the edge agent. According to certain examples, the edge cloud service can train machine learning models on performance data and vulnerability data, gathered by the edge agent, to determine security scores. Other rules and configurations may also be used to generate security scores such as by tracking event volumes, identifying a number of distinct IP or MAC addresses, identifying traffic anomalies, and monitoring other metrics associated with the performance data and vulnerability data. Based on determined security scores, the edge cloud service can transmit messages back to the edge agent for execution.

Certain aspects described herein overcome the limitations of previous techniques for maintaining the security within computing environments and networks. While some solutions have supported alerts or webhooks, and have relied on end users or other systems after alerts are triggered, the discussed techniques here provide for closed loop actions which can automatically be triggered within the computing environment to enhance computer security. Moreover, the described techniques necessarily relate to computer technology, and improve security in computing environments as discussed below.

Several measures can be provided for ensuring the security and integrity of access to various computing systems, databases, and online interactions. For example, security scores for computer networks are discussed which are generated to determine the risk associated with potential threat actors with access to an edge system within a larger computing network and infrastructure. The security scores are generated based on computer environment specific data including performance data premised on network performance data and logging. The security scores can further be generated based on vulnerability data, where the vulnerability data relates to network specific risks gathered from software such as honeypot systems. Therefore, the acts of monitoring performance data and vulnerability data to generate security scores necessarily relate to application within computer environments.

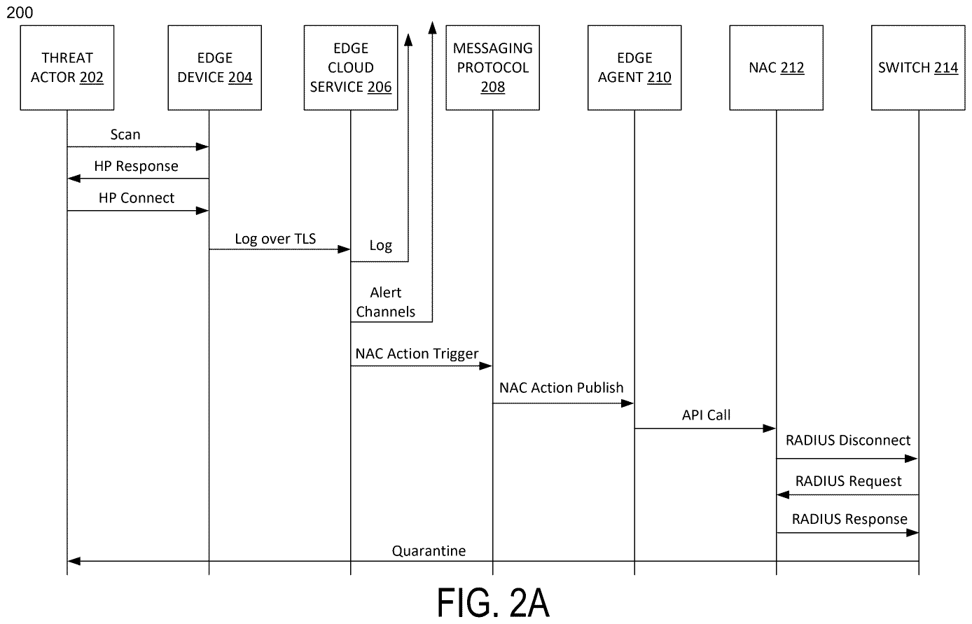

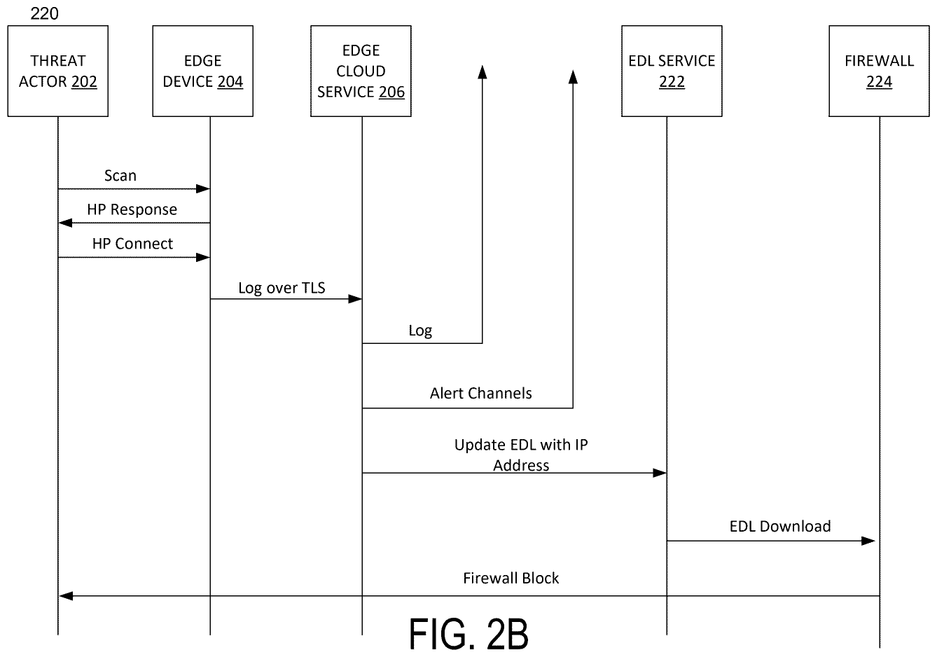

Moreover, the generated security scores are used to generate mitigating actions implemented in a closed loop environment to improve the functionality of computing devices within a larger computing environment. Mitigating actions relate to specific sequences of controlling access to a network, e.g., via configuring network access controls, such as in FIG. 2A below, updating external dynamic lists, such as in FIG. 2B below, and additional techniques for improving the security and functionality of computer networks. Therefore, the techniques discussed are not only implemented within computing environments, but further provide improvements directly related to such computing environments by improving network security.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Network Security Monitoring and Enforcement

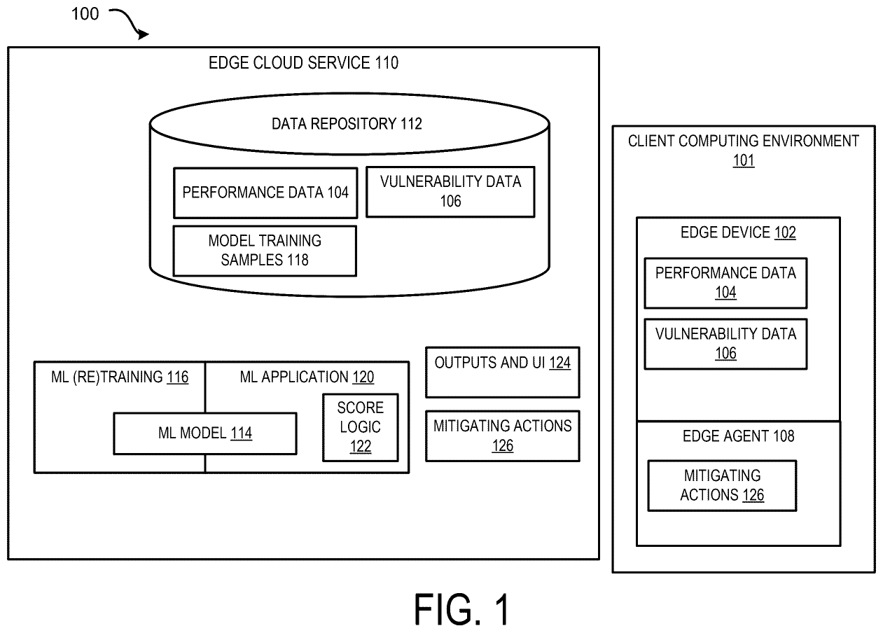

Referring now to the drawings, FIG. 1 is a block diagram depicting an example of a computing environment in which a network security monitoring system can generate closed loop actions to remedy determined security threats, according to certain examples. The operating environment 100 is shown including a client computing environment 101 including an edge device 102 and edge agent 108. The edge device 102 is a device that can communicatively couple to wired (e.g., client devices within the client computing environment 101) and wireless network environments (e.g., edge cloud service 110).

The edge device 102 can operate in multiple modes including a performance monitoring mode, also referred to as digital experience monitor mode, where the edge device 102 acts as a client and executes various tests to verify network performance as the performance data 104. The edge device 102 can also operate in a security mode, also referred to as security experience monitor mode, where the edge device 102 operates as a honeypot system and reports security events and performance as vulnerability data 106. The honeypot system can act as a decoy system, luring threat actors to uncover attack methods. In either mode, the edge device 102 will also report attacks that are identified as directly targeting the edge device 102. All performance data 104 and vulnerability data 106 may be uploaded to the edge cloud service 110 for processing, correlation, alert generation, and action determination. In some examples, the edge device 102 may be caused to operate in both the performance monitoring mode and the security mode concurrently, while in other examples, the edge device 102 may be caused to operate only in one mode at any given time.

When operating in performance mode, the edge device 102 can perform various network diagnostic tests including Domain Name System (“DNS”) tests, HyperText Transfer Protocol (“HTTP”) tests, Internet Control Message Protocol (“ICMP”) ping tests, Transmission Control Protocol (“TCP”) tests, wireless and speed tests, and the like. The tests may be conducted by probes to collect real-time performance metrics for assessing network health and performance. The probes can push performance data to the edge cloud service 110. Performance data can be stored and managed, for instance by Amazon Web Service Managed Streaming for Apache Kafka (“AWS MSK”) for subsequent processing.

When operating in security mode, the edge device 102 can track logs and alerts generated by intrusion detection systems (e.g., Suricata). Additionally, security events can be captured by honeypot systems to monitor malicious activity. Tools such as AWS MSK can push the data to the edge cloud service 110 where the vulnerability data 106 may be stored in one or more data repositories 112 such as a ClickHouse database.

Deployed within the same client computing environment 101 as the edge device 102, the edge agent 108 can include programmable logic for executing closed loop actions. The edge agent 108 can receive messages generated by the edge cloud service 110 and execute local actions to affect closed loop mitigating actions 126 based on the vulnerability data 106 and predictions generated by the edge cloud service 110. Mitigating actions can include signaling to a user-on-premises Network Access Control (“NAC”) system that a certain endpoint is a threat actor, resulting in either quarantine or disconnection of the associated device. If the operating environment 100 also includes block lists, such as an external dynamic list (“EDL”) service, the edge agent 108 can also update user specific block lists as a mitigation control. Example operations and sequences of operations of the edge device 102, the edge agent 108, and the edge cloud service 110 are described with respect to FIGS. 2A-2B.

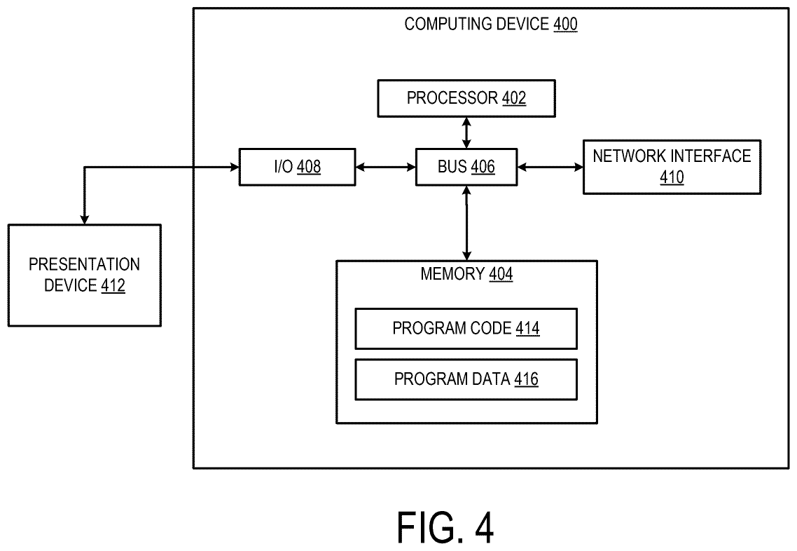

The edge device 102 and the edge agent 108, within the client computing environment 101, may be communicatively coupled to the edge cloud service 110. The edge cloud service 110 can include any network configuration communicatively coupling the components described within, such as a distributed computing environment and the like. In some examples, the client computing environment 101 can be implemented on one or more hardware devices, such as those described with respect to FIG. 4.

The edge cloud service 110 can ingest, enrich, correlate, and store various data including the performance data 104 and the vulnerability data 106 as received by deployed edge devices 102. For instance, the performance data 104 and the vulnerability data 106 may be stored within a data repository 112 within the edge cloud service 110. Examples of the data repository 112 can include ClickHouse database, other column-oriented database management systems, or any other database management systems more generally. The data repository 112 can host materialized views to pre-aggregate data and improve query performance. The performance data 104 and the vulnerability data 106, within the edge cloud service 110, may then be used to generate model training samples 118 for application with one or more machine learning models 114. For instance, training samples may include time-bounded subsets of the performance data 104 and the vulnerability data 106 (e.g., daily, weekly, monthly or the like).

The edge cloud service 110 can include the model training application 116 for training the machine learning model(s) 114 based on the model training samples 118, where the model training samples 118 can include the performance data 104 and the vulnerability data 106. Raw data from the model training samples 118 can be transformed into meaningful features through techniques including aggregation, transformation, and normalization. The ML application 120 can further prepare the dataset to be compatible with various model requirements. Training can include supervised and unsupervised learning (e.g., clustering using K-means for health scoring). The model training application 116 can also perform model validation to ensure the machine learning model(s) 114 meet performance criteria. Validation metrics such as silhouette scores may be logged for quality assurance. Validated models may be registered in various registries for versioning and traceability, and the latest model from the registry may be deployed rendering the machine learning model(s) 114 used as part of the edge cloud service available for real-time inferencing.

The machine learning model(s) 114 may be used to derive performance metrics and scores as indicators of network performance and security of the operating environment 100, including specifically the client device storing the edge device 102 and the edge agent 108. The machine learning models are also used to correlate possible security events and incidents based on all data observed for a given customer (e.g., as acquired by the edge device 102). Prediction and scores generated by the machine learning model(s) 114 may be executed periodically, i.e., every 5 minutes, to process incoming real-time data. The scores and predictions may be compared against predefined thresholds to generate alerts, and can further be forwarded for visualization and notifications per output and user interface logic 124.

For instance, the machine learning model scores can be applied within an ML application 120 on the edge cloud service 110, where the ML application 120 couples the machine learning model outputs to score logic 122. The score logic 122 can include configurable thresholds and other logic used to specify actions as further determined by the output and user interface (“UI”) logic 124. The output and UI logic 124 can determine, based on the score logic 122, what actions to trigger, such as alerts to administrators or other users. Output and UI logic can further determine local closed loop mitigating actions. The edge cloud service 110 can then send messages including alerts and mitigating actions to the edge agent 108 for execution.

The mitigating actions 126 can include closed loop actions executed in the client computing environment 101 based on network and/or security events (i.e., based on the performance data 104 and/or the vulnerability data 106, respectively). Such mitigating actions can include updating and executing network access control protocols, updating a firewall via updating the EDL, transmitting messages to endpoint detection and response (“EDR”) platforms, changing routing and Software-Defined Wide Area Network (“SDWAN”) policies, disabling user accounts, and managing cloud security group membership, among other techniques.

The model training application 116 can include one or more processing devices that execute program code. The program code is stored on a non-transitory computer-readable medium. The model training application 116 can execute one or more processes to execute and/or retrain the machine learning model(s) 114 for generating security scores based on the performance data 104, the vulnerability data 106, and the model training samples 118.

Network-attached storage units may store a variety of different types of data organized in a variety of different ways and from a variety of different sources. For example, the network-attached storage unit may include storage other than primary storage located within the model training application 116 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory, or memory devices.

Furthermore, the edge cloud service 110 can communicate with various other computing systems, such as client computing environments 101. For example, client computing environments 101 may send the performance data 104 and the vulnerability data 106 to determine a severity score for a given entity or action or may send signals to the edge cloud service 110 that control or otherwise influence different aspects of the edge cloud service 110 or the edge agent 108. The client computing environments 101 and the edge cloud service 110 may also interact with user computing systems via one or more public data networks to facilitate interactions between users of the client computing environment 101 and the edge cloud service 110.

Client computing environment 101 may include one or more third-party devices, such as individual servers or groups of servers operating in a distributed manner. Client computing environment 101 can include one or more server devices. The one or more server devices can include or can otherwise access one or more non-transitory computer-readable media. The client computing environment 101 can also execute instructions that provide an interactive computing environment accessible to user computing systems. Examples of the interactive computing environment include a mobile application specific to a particular client computing system, a web-based application accessible via a mobile device, etc. The executable instructions are stored in one or more non-transitory computer-readable media.

The client computing environment 101 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system to access various functions of the interactive computing environment.

In some examples, the operating environment 100 may have other computing resources associated therewith (not shown in FIG. 1), such as server computers hosting and managing virtual machine instances for providing cloud computing services, server computers hosting and managing online storage resources for users, server computers for providing database services, and others. The interaction between the edge cloud service 110 and the client computing environment 101 may be performed through graphical user interfaces presented by the client computing environment 101 to a user computing system, or through an application programming interface (“API”) calls or web service calls.

Each communication within the operating environment 100 may occur over one or more data networks, such as a public data network, a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate may be instead implemented in a single device or system.

### Example Sequences of Operations for Providing Closed Loop Network Security

FIGS. 2A and 2B are sequence diagrams depicting example sequences of operations for providing closed loop network security on edge devices, according to certain examples. For illustrative purposes, the sequences 200 and 220 are described with reference to implementations described above with respect to one or more examples described herein. Other implementations, however, are possible. In some aspects, the operations in FIGS. 2A and 2B may be implemented in program code that is executed by one or more computing devices such as the edge cloud service 110 and client computing environment 101 depicted in FIG. 1. In some aspects of the present disclosure, one or more operations shown in FIGS. 2A and 2B may be omitted or performed in a different order. Similarly, additional operations not shown in FIGS. 2A and 2B may be performed.

Turning to FIG. 2A, a sequence diagram 200 is shown including a threat actor 202 initiating the sequence by scanning for services on the edge device 204. The threat actor 202 can include any entity with access to the edge device 204 looking to establish unauthorized access and/or impair the functionality of the edge device 204 or any network associated with the edge device 204. In response to receiving and registering a scan for services by the threat actor, the edge device 204 can respond by providing the threat actor with access to honeypot services. The threat actor 202 then connects to the honeypot service on the edge device 204.

Concurrently or subsequent to the threat actor connecting to the edge device 204, the edge device 204 communicates to the edge cloud service 206 to log the threat actor's connection to the honeypot service and associated metadata. The communication between the edge device 204 and the edge cloud service 206 can include transporting system log messages (“Syslog”) over transport layer security (“TLS”) protocol.

Upon reception by the edge cloud service 206, the communications from the edge device 204 (e.g., the Syslog message) can be logged for further analysis, for instance, via log management on the edge cloud service 206. The communications can be transmitted to one or more alert channels. Alert channels can include logs such as Security Orchestration, Automation, and Response (“SOAR”), and other services including Salesforce Networking (“SFDC”), SNOW Atlas and the like. Alert channels can also include transmission through other services including Email.

In addition or alternatively to logging and transmitting communications from the edge device 204, the edge cloud service 206 can further trigger and initiate NAC actions and protocols, transmitted according to one or more messaging protocols to the edge agent 210. Messaging protocols can include, for instance, message queuing telemetry transport (“MQTT”). Other examples of possible messaging protocols can include advanced messaging queuing protocol (“AMQP”), Constrained Application Protocol (“CoAP”), HTTP, and the like.

The sequence 200 includes receiving at the edge agent 210, the communications from the edge cloud service 206 via the messaging protocol 208. According to some examples, the messaging protocol 208 can convert the communications received from the edge cloud service 206 prior to delivery to the edge agent 210. For example, NAC actions, transmitted via the edge cloud service 206 as triggers, can be published to the edge agent 210 according to the messaging protocol 208.

The edge agent 210, receiving the communications from the edge cloud service 206 via the messaging protocol 208 can trigger actions as instructed by the edge cloud service 206. In an example, the edge agent 210 can initiate an API call to RADIUS/NAC protocols 212 to initiate one or more actions ultimately imposed on the threat actor 202.

RADIUS/NAC protocols 212 can be complemented with additional network security technologies and protocols, including Remote Authentication Dial-In User Services (“RADIUS”) for communications with network switches 214. The network switch 214 can be used to manage and enforce authentication (e.g., based on determinations made via the edge cloud service 206 communicated via the sequence flow to the switch 214). In an example where NAC protocols and RADIUS protocols are combined as part of the larger NAC infrastructure, RADIUS can disconnect the switch 214 based on the API call received from the edge agent 210. To do so, the RADIUS/NAC protocol 212 can transmit a Change of Authorization (“CoA”) packet to the switch 214. In response, the switch 214 can transmit a RADIUS request packet back to the RADIUS/NAC protocol 212. The RADIUS/NAC protocol 212 can then respond to the switch via packets indicating whether to quarantine and/or disconnect the threat actor. In response, the switch 214 may then impose the action on the threat actor by quarantining and/or disconnecting the threat actor 202 as instructed by the RADIUS/NAC protocols 212 as further instructed by the edge agent 210.

Turning to FIG. 2B, a sequence diagram 220 is shown. The sequence 220 of FIG. 2B includes a similar sequence as sequence 200 of FIG. 2A, but diverges with respect to communications via the edge cloud service 206. Thus, sequences between the threat actor 202 and edge device 204, edge device 204 and the edge cloud service 206, and some operations execute via the edge cloud service 2-6 such as logging and transmission via alert channels as discussed with respect to sequence 200 of FIG. 2A, are similarly incorporated into the discussion of FIG. 2B.

However, in FIG. 2B, in addition or alternatively to the RADIUS/NAC and switch sequences of FIG. 2A, the sequence 220 includes communications between the edge cloud service 206 and an external dynamic list service 222. The edge cloud service 206, communicating with the EDL service 222 can update the EDL with endpoints including those associated with the threat actor 202 transmitted per sequence 220 ultimately to the EDL service 222.

The EDL service 222 can maintain a log of endpoints associated with perceived threats such as the IP or media access control (“MAC”) addresses of threat actors 202 transmitted via the edge cloud service 206. The EDL service 222 log may be updated in direct response to communications and updates via the edge cloud service 206. Additionally, a firewall 224 can periodically, or in real-time, download lists of endpoints from the EDL service 222. Periods for download of the EDL service 222 log can be configured to be hourly, daily, weekly, and the like. Downloads may be supported via HTTP or other transmission protocols. In response to downloading endpoints from the EDL service 222, the firewall 224 can block traffic of the threat actor 202 based on the endpoints of the threat actor 202 as downloaded via the EDL service 222.

### Example Operations for Closed Loop Security Access Control

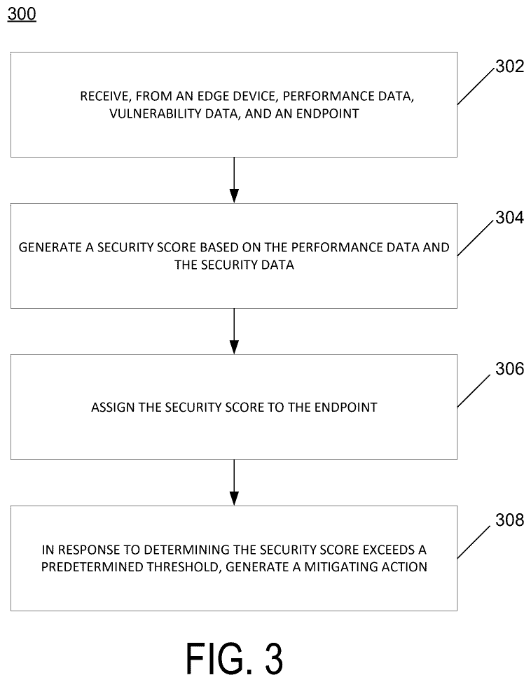

Closed loop actions based on network and/or security events triggering mitigation actions can improve network security. FIG. 3 is a flow diagram of a process for executing closed loop actions to implement security access control, according to certain examples. For illustrative purposes, the process 300 is described with reference to implementations described above with respect to one or more examples described herein. Other implementations, however, are possible. In some aspects, the operations in FIG. 3 may be implemented in program code that is executed by one or more computing devices such as the edge cloud service 110 and client computing environment 101 depicted in FIG. 1. In some aspects of the present disclosure, one or more operations shown in FIG. 3 may be omitted or performed in a different order. Similarly, additional operations not shown in FIG. 3 may be performed.

At block 302, the process 300 involves receiving, from an edge device 102, performance data 104, vulnerability data 106, and an endpoint. The edge device 102 can collect the performance data 104 while in a performance monitoring mode by performing various network diagnostic tests including DNS tests, HTTP and HTTPS tests, ICMP Ping tests, TCP tests, wireless and speed tests, and the like. The edge device 102 can collect the vulnerability data 106 while in a security mode, where honeypot services can be used to collect and report security events. The edge device 102 can then transmit the performance data 104 and the vulnerability data 106 to the edge cloud service 110, acting as the computing device. The endpoint, such as an IP address, MAC address, or the like, can relate to potential threat actors and can be received via analyzing events generated by intrusion detection systems such as Suricata, honeypot systems, and other probe devices. For instance, when a threat actor, or potential threat actor accesses the edge device 102, the edge device 102 can respond by providing the threat actor access to the honeypot system. The honeypot system can thus initially detect and deflect threat actors while recording their endpoint(s) transmitted to the computing device. In some examples, the endpoint can be included within the vulnerability data 106, or the performance data 104. In such examples, the process 300, implemented via the edge cloud service for instance, can identify the endpoint based on one or more of the vulnerability data and the performance data.

At block 304, the process involves generating a security score based on the performance data 104 and the vulnerability data 106. The performance data 104 and vulnerability data 106, initially received from the edge device 102, can be stored in the computing system, e.g., with the data repository 112 such as a ClickHouse database. Over time, the performance data 104 and the vulnerability data 106 can correspond to a period of events by various threat actors, for instance over daily, weekly, or bi-weekly periods. The performance data 104 and the vulnerability data 106 may then be retrieved from the data repository 112 based on various time periods and correlated to generate the security score representing the severity of a given action initiated by various threat actors. Security scores can include various metrics or weighted combination of such metrics.

According to some examples, security scores can be determined according to various configurable rules within the score logic 122 instructions that react to performance data 104 and vulnerability data 106 received from the edge device 102. Security scores can be generated, for instance, based on metrics related to event severity, event volume, endpoint diversity, traffic anomalies, attack frequencies, alert burstiness, persistence, or a combination of one or more of such metrics.

Event severity reflects the criticality of an alert. Higher severity indicates more dangerous or impactful events such as successful attacks or breaches. By considering event severity, the event severity metric penalizes probes detected via the edge device 102 that encounter more severe security threats. Generally, various network security events may have assigned severity scores. For example, identified data exfiltration events may be assigned a heightened severity score compared to identified network scanning events. A baseline event severity can include a metric reflecting a normalized mean of the event severity scores assigned to various events received from a plurality of edge devices communicating with the edge cloud service. The event severity associated with a series of probes on the plurality of edge devices. Event severity scores for a given edge device can be determined by identifying a severity score assigned to an event on the specified edge device, and comparing the severity score to the baseline event severity determined by aggregated event severity scores assigned to previous device probes accessed from the plurality of edge devices. Event security metrics can also be determined by calculating the normalized mean or average of alert severity values associated with security events detected by the edge device 102 over a specified time window.

Event volume indicates the volume of alerts generated during a given timeframe. A high event volume can signify a persistent threat or attack, such as a distributed denial of service (“DDoS”) attack. A max event count may be employed as a threshold for what is considered a high volume, for instance, based on historical averages. Event volume metrics can be determined by identifying the total number of events (e.g. security alerts) generated by the edge device 102 within a defined time interval and comparing the determined event volume to a predefined threshold event count. The threshold can be determined based on monitoring security alerts generated by a plurality of devices, including the edge device and one or more additional devices over a historical baseline period, and calculating an average or statistical upper bound (e.g., a percentile or standard deviation) for alert volumes during typical operation. For example, the threshold may be set by aggregating alert counts from similar network environments or devices, determining the typical maximum value observed during non-attack periods, and selecting a threshold that distinguishes normal fluctuations from anomalous, high-volume events indicative of attacks.

Source diversity reflects the number of distinct source IP addresses (or endpoints more generally) involved in the alerting activity. A larger diversity of source IP's indicates a more distributed and potentially coordinated attack. A maximum number of unique sources can be employed to further flag the number of sources. Source diversity metrics can be determined by counting the number of unique source IP addresses, MAC addresses, or other endpoint identifiers that have generated alerts or been associated with security events in the given timeframe. The count can then be compared to a configured maximum or baseline to assess whether an attack is distributed or coordinated. Source diversity metrics can be assigned to an individual endpoint, such as the edge device, by tracking and aggregating the number of unique endpoints that have targeted or interacted with that specific endpoint (e.g., the edge device) during the monitoring period.

Traffic anomalies can be detected by comparing the source (e.g., the endpoint) and destination traffic metrics. Anomalies such as sudden spikes in traffic or unusually high data transfer can indicate an attack, such as a data exfiltration or network reconnaissance. Anomaly level metrics may be calculated by comparing the observed traffic (e.g., bytes, packets) received by the endpoint to baseline behavior, where thresholds for what is considered anomalous. Traffic anomaly metrics can be assigned to an individual endpoint, such as the edge device, by identifying one or more anomalies in inbound traffic to or outbound traffic from the edge device (e.g., including unexpected protocol or port usage, repeated connection attempts, high data transfer volumes), and identifying a severity or frequency of the one or more anomalies to further determine a traffic anomaly metric for the edge device.

Attack frequency, such as repeated attempts from an endpoint or over a time period increases the likelihood of a sustained attack. Higher attack frequencies may indicate a more persistent and dangerous threat. Attack frequency metrics may be determined based on how often similar attacks occur in a given timeframe. Attack frequency metrics can be assigned to an individual endpoint, such as the edge device, by tracking the number of repeated attack events or security alerts originating from the endpoint or targeting the endpoint, within specific monitoring intervals. For the edge device, monitoring attack frequency can include identifying one or more attack patterns based on the performance and vulnerability data, such as the number of intrusion attempts, or exploit events associated with that device. The attack frequency can be determined by identifying the number of attacks identified based on the attack patterns. The determined attack frequency can be compared against various configurable attack frequency thresholds to assign an attack frequency score, which may in turn modify the security score. The attack frequency thresholds can be configured to be static, or can be variable. Variable attack frequency thresholds can be determined based on attack frequencies monitored and aggregated from a plurality of edge devices interfacing with the edge cloud service.

Alert burstiness refers to the intensity or volume of alerts in given time windows. Sudden spikes in alerts in a shorter timeframe (burstiness) often indicates a coordinated attack or a rapidly evolving threat. Alert spikes over a preconfigured period may be compared against a baseline alert frequency, where the baseline alert frequency can be determined based on historical alert data. Alert burstiness metrics can be assigned to an individual endpoint, such as the edge device, based on analyzing the distribution and concentration of alerts over short, specific monitoring intervals, and comparing the observed number of alerts for the endpoint against rolling alert frequency average for similar periods. If the edge device experiences a sudden spike (i.e., over a threshold variation) in alerts relative to its normal activity, the burstiness metric can be then weighted to reflect the change in alert velocity.

Persistence indicates how long an attack has been ongoing. Attacks that persist over time, rather than being one-time events can be scored in relation to perceived severity. Persistence scores can be determined by identifying attack patterns based on the performance and vulnerability data and evaluating a duration of the attack pattern. Attack patterns can include attempted data exfiltration, beaconing to attacker infrastructure, scheduled network scanning, backdoor creation, and the like. Attack patterns can be identified from the performance and vulnerability data by correlating the timing performance and vulnerability data. Persistence metrics can be assigned to an individual endpoint, such as the edge device, based on measuring the identified duration or the number of continuous or recurring alert-generating events associated with that endpoint across consecutive monitoring windows.

In some examples, each of the above metrics may be weighted together to formulate the severity score. In other words, the severity score can be based in full, or at least in part, on various combinations of the above-described metrics and scores. Various combinations, or single metrics may be used to generate the severity score. Additionally or alternatively, one or more of the metrics may serve as attributes for input into a machine-learning model which may be trained on previous performance data and previous vulnerability data and configured to correlate performance data 104 to vulnerability data and further predict severity scores. The previous performance data and previous vulnerability data may be gathered from one or more of the same endpoint or other endpoints communicatively coupled to the edge cloud service 110.

Generating the security score based on the performance data 104 and the vulnerability data 106 can include correlating the performance data 104 and the vulnerability data 106 via machine learning techniques. Generating the security score can include generating the model training samples 118 based on the performance data 104 and the vulnerability data 106 to train the machine learning model(s) 114 to output security scores. For instance, the model training samples 118, including the performance data 104 and the vulnerability data 106, can be generated on a weekly basis, prepared, preprocessed, and features extracted for implementation within the machine learning model(s) 114. Model training, via the model training application 116, may include supervised or unsupervised learning and the machine learning model may be subsequently validated prior to deployment. The machine learning model(s) 114 may be updated periodically to match updates in the gathered performance data and vulnerability data to provide real time inferencing. Model updates can lead to logging each validated machine learning model for traceability and versioning. Once trained, validated, and deployed, the machine learning model may thus be configured to generate security scores based on correlating the performance data 104 and the vulnerability data 106.

At block 306, the process 300 involves assigning the security score to the endpoint. Each endpoint, associated with an entity that can include threat actors, can be assigned a security score based on respective performance data and vulnerability data. For instance, actions traced to the endpoint within a honeypot system can provide vulnerability data and/or performance data. Based on the correlations between the performance data and vulnerability data which can be performed per block 304, security scores can be generated based on the endpoint's respective performance data and vulnerability data. The security score may then be assigned to the endpoint for further tracking.

At block 308, the process 300 involves, in response to determining the security score exceeds a predetermined threshold, generating a mitigating action where the mitigating action reduces accessibility of the endpoint to a computing network. Depending on the threshold, and the implementation, different mitigating actions can be generated. Mitigating actions can include, for instance, managing network access control associated with the endpoint, where the endpoint can include an IP address, MAC address, or the like, updating a firewall external dynamic list, updating an endpoint detection and response (“EDR”) protocol, updating a routing configuration or a software-defined area network policy, disabling a user account, updating a cloud security group membership list, and the like. Specific examples of implementing mitigating actions are discussed with respect to FIG. 2A (discussing NAC management) and 2B (discussing updating an EDL and firewall configuration).

### Example of Computing System for Network Security Monitoring and Enforcement

Any suitable computing system or group of computing systems can be used to perform the operations for the machine-learning operations described herein. For example, FIG. 4 is a block diagram depicting an example of a computing device, which can be used to implement instructions executed via the edge cloud service 110 and/or the client computing environment 101 according to certain examples. The computing device 400 can include various devices for communicating with other devices in the operating environment, as described with respect to FIG. 1. The computing device 400 can include various devices for performing one or more transformation operations described above with respect to FIGS. 1-3.

The computing device 400 can include a processor 402 that is communicatively coupled to a memory 404. The processor 402 executes computer-executable program code stored in the memory 404, accesses information stored in the memory 404, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 402 include a microprocessor, an application-specific integrated circuit, a field-programmable gate array, or any other suitable processing device. The processor 402 can include any number of processing devices, including one. The processor 402 can include or communicate with a memory 404. The memory 404 stores program code that, when executed by the processor 402, causes the processor to perform the operations described in this disclosure.

The memory 404 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Python, Perl, JavaScript, ActionScript, etc.

The computing device 400 may also include a number of external or internal devices such as input or output devices. For example, the computing device 400 is shown with an input/output interface 408 that can receive input from input devices or provide output to output devices. A bus 406 can also be included in the computing device 400. The bus 406 can communicatively couple one or more components of the computing device 400.

The computing device 400 can execute program code 414 that includes instructions executing operations on the edge cloud service 110 and/or the client computing environment 101, edge device 102, and the edge agent 108. The program code 414 for the edge cloud service 110 and/or the client computing environment 101 edge device 102 and the edge agent 108 may be resident in any suitable computer-readable medium and may be executed on any suitable processing device. For example, as depicted in FIG. 4, the program code 414 for the edge cloud service 110 and/or the client computing environment 101 edge device 102 and edge agent 108 can reside in the memory 404 at the computing device 400 along with the program data 416 associated with the program code 414, such as the model training application 116 and the mitigating actions 126.

In some aspects, the computing device 400 can include one or more output devices. One example of an output device is the network interface device 410 depicted in FIG. 4. A network interface device 410 can include any device or group of devices suitable for establishing a wired or wireless data connection to one or more data networks described herein. Non-limiting examples of the network interface device 410 include an Ethernet network adapter, a modem, etc.

Another example of an output device is the presentation device 412 depicted in FIG. 4. A presentation device 412 can include any device or group of devices suitable for providing visual, auditory, or other suitable sensory output. Non-limiting examples of the presentation device 412 include a touchscreen, a monitor, a speaker, a separate mobile computing device, etc. In some aspects, the presentation device 412 can include a remote client-computing device that communicates with the computing device 400 using one or more data networks described herein. In other aspects, the presentation device 412 can be omitted.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification that terms such as “processing,” “computing,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computing systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Any aspects or examples may be combined with any other aspects or examples. Accordingly, it should be understood that the present disclosure has been presented for purposes of example rather than limitation, and does not preclude inclusion of such modifications, variations, or additions to the present subject matter as would be readily apparent to one of ordinary skill in the art.

What is claimed is:

1. A non-transitory computer-readable storage medium having program code executable by a processing device to perform operations comprising:
receiving, from an edge device, performance data, vulnerability data, and an endpoint;
generating a security score based on the performance data and the vulnerability data;
assigning the security score to the endpoint; and
in response to determining the security score exceeds a predetermined threshold, generating a mitigating action that reduces accessibility of the endpoint to a computing network.

2. The non-transitory computer-readable storage medium of claim 1, wherein the mitigating action includes one or more of:
updating a network access control associated with the endpoint; or
updating a firewall external dynamic list (EDL).

3. The non-transitory computer-readable storage medium of claim 1, wherein generating the performance data includes correlating the performance data and the vulnerability data based on a machine learning model trained on previous performance data and previous vulnerability data.

4. The non-transitory computer-readable storage medium of claim 1, wherein the mitigating action comprises updating a network access control associated with the endpoint, and the mitigating action is performed by executing, on the edge device, a Remote Authentication Dial-In User Services (RADIUS) protocol to quarantine the endpoint.

5. The non-transitory computer-readable storage medium of claim 1, wherein generating the security score based on the performance data and the vulnerability data comprises:
establishing a baseline alert frequency based on historical alert data;
monitoring a rolling alert frequency over a preconfigured period; and
responsive to identifying a threshold variation between the rolling alert frequency and the baseline alert frequency, increasing the security score.

6. The non-transitory computer-readable storage medium of claim 1, wherein generating the security score based on the performance data and the vulnerability data comprises:
identifying one or more anomalies in inbound traffic to or outbound traffic from the edge device;
identifying a severity or frequency of the one or more anomalies to further determine a traffic anomaly metric for the edge device; and
generating the security score based at least in part on the traffic anomaly metric.

7. The non-transitory computer-readable storage medium of claim 1, wherein the performance data is received from the edge device while the edge device is caused to operate in a performance monitoring mode, and wherein the vulnerability data is received from the edge device while the edge device is caused to operate in a security mode.

8. A computer-implemented method comprising:
receiving, by a processor and from an edge device, performance data, vulnerability data, and an endpoint;
generating, by the processor, a security score based on the performance data and the vulnerability data;
assigning, by the processor, the security score to the endpoint; and
in response to determining the security score exceeds a predetermined threshold, generating, by the processor, a mitigating action that reduces accessibility of the endpoint to a computing network.

9. The computer-implemented method of claim 8, wherein the mitigating action includes one or more of:
updating an endpoint detection and response (EDR) protocol; or
updating a routing configuration or a software-defined area network policy.

10. The computer-implemented method of claim 8, wherein generating the performance data includes correlating the performance data and the vulnerability data based on a machine learning model trained on previous performance data and previous vulnerability data.

11. The computer-implemented method of claim 8, wherein the mitigating action comprises updating a network access control associated with the endpoint, and the mitigating action is performed by executing, on the edge device, a Remote Authentication Dial-In User Services (RADIUS) protocol to quarantine the endpoint.

12. The computer-implemented method of claim 8, wherein generating the security score based on the performance data and the vulnerability data comprises:
establishing, by the processor, a baseline event severity based on accessing aggregated event severity scores assigned to previous device probes received from a plurality of devices;
identifying, by the processor and based on the vulnerability data, a severity score assigned to an event; and
responsive to identifying a threshold variation between the severity score and the baseline event severity, increasing, by the processor, the security score.

13. The computer-implemented method of claim 8, wherein generating the security score based on the performance data and the vulnerability data comprises:
identifying, by the processor and based on the performance data, an event volume representing a number of events associated with the edge device over a defined time interval; and
responsive to the event volume exceeding a threshold event count, modifying, by the processor, the security score.

14. The computer-implemented method of claim 8, wherein the performance data is received from the edge device while the edge device is caused to operate in a performance monitoring mode, wherein the vulnerability data is received from the edge device while the edge device is caused to operate in a security mode, and wherein the edge device is configured to operate in the performance monitoring mode concurrently.

15. A system comprising:
a processing device; and
a memory device in which instructions executable by the processing device are stored for causing the processing device to perform operations comprising:
receiving, from an edge device, performance data, vulnerability data, and an endpoint;
generating a security score based on the performance data and the vulnerability data;
assigning the security score to the endpoint; and
in response to determining the security score exceeds a predetermined threshold, generating a mitigating action that reduces accessibility of the endpoint to a computing network.

16. The system of claim 15, wherein generating the security score based on the performance data and the vulnerability data comprises:
identifying one or more attack patterns based on the performance data and the vulnerability data;
determining an attack frequency score based on a number of identified attack patterns exceeding an attack frequency threshold; and
generating the security score based at least in part on the attack frequency score.

17. The system of claim 15, wherein generating the performance data includes correlating the performance data and the vulnerability data based on a machine learning model trained on previous performance data and previous vulnerability data.

18. The system of claim 15, wherein the mitigating action comprises updating a network access control associated with the endpoint, and the mitigating action is performed by executing, on the edge device, a Remote Authentication Dial-In User Services (RADIUS) protocol to quarantine the endpoint.

19. The system of claim 15, wherein generating the security score based on the performance data and the vulnerability data comprises:
modifying the security score based a number of unique endpoints that have interacted with the edge device.

20. The system of claim 15, wherein generating the security score based on the performance data and the vulnerability data comprises:
identifying an attack pattern based on the performance data and the vulnerability data;
determining a persistence score based on an identified duration of the attack pattern; and
generating the security score based at least in part on the persistence score.
